(19) United States
(12) Patent Application Publication
(10) Pub. No.: US 2001/0034835 A1
(43) Pub. Date: Oct. 25, 2001

(54) Applied digital and physical signatures over telecommunications media

(76) Inventor: Robert E. Smith, Bellevue, WA (US)

Correspondence Address: PERKINS COIE LLP, PATENT-SEA, P.O. BOX 1247, SEATTLE, WA, 98111-1247, US

(21) Appl. No.: 09/795,923

(22) Filed: Feb. 28, 2001

Related U.S. Application Data
(60) Provisional application No. 60/185,718, filed on Feb. 29, 2000.

(51) Int. Cl. H04L 9/00

(52) U.S. Cl. 713/175

(57) ABSTRACT

A Message Authentication Code (MAC), which may be used with Public Key Authentication, assures that the content elements have not been altered and that the issuer is who they say they are. This is accomplished by encrypting the documents hash count using the issuer's private key. The content element's receiving party can verify the MAC using the issuer's Public Key.

### CROSS-REFERENCE TO RELATED APPLICATION

This application claims the benefit of U.S. Provisional Patent Application No. 60/185,718, filed Feb. 29, 2000, currently pending.

### TECHNICAL FIELD

This disclosure relates generally to automated information security systems.

### BACKGROUND

There are three prevailing technologies that generally pertain to applying electronic signatures and authentication of electronically signed documents or “containers”. These are digitized physical signatures of a signer, electronic signature and public key authentication. Although there are numerous types of electronic watermarks none presently contain tables or other objects within them.

Digitized signature technology is based upon capturing a signature image as a bit map that can be optionally converting it into a vector format image. This allows a system to reproduce a person's signature and store it in a computer file. Variations of this include capturing pressure and speed at which a person signs their name and using this information as biofeedback to build a signer's profile table. The problem with biofeedback is that it takes several signatures in order for the learning algorithm to build signature parameters and it never achieves 100% reliability.

There are many types of electronic signatures but the prevailing standard incorporates Public Key/Private Key technology (reference: “Applied Cryptography, ” by Bruce Schneier, published by Wiley 1996). This technology relies on “trusted” Third Parties to administer electronic signature keys.

Many weaknesses exit in digital and electronic signatures due to required procedures of the receiving party in order to transfer liability. For this reason physical signatures continue to dominate for legal purposes even within new electronic signature legislation. At issue are security weaknesses in network protocols, operating systems and trusted third party key management. When the Internet is involved with Public Key electronic signature, the receiving party must have knowledge and take correct action to verify the authentication of the signer. Even if the receiving party takes proper action, no audit trail can be invoked over the Internet to show such action was taken.

The problem in Internet browser programs, such as Java, ActiveX, and their interface to transport formats schemas such as the SGML family of languages (HTML through XML) is that these formats do not provide a means of handling signatures that fully transfer liability with the transaction in forms or documents that are exchanged. Presently Internet forms will capture User data inputs in a way that requires the data to be specially submitted but after the data is entered the user receives only a reference number associated with the transaction as a receipt. This type of transaction is open for abuse by both parties and lacks signature (taking credit card information without a signature or the user makes claim of accidental click on the submit button on the screen). Interactive signatures do not exist.

Signatures on documents can be exchanged, but not interactively, on any scanned in document. These documents are commonly know as “.gif,” “.pdf,” “.img,” or bit maps with document extensions used by application readers or viewers. One type of existing security is found in U.S. Pat. Nos. 6,091,835, 6,064,751 and 5,818,955.

### SUMMARY

The present invention overcomes the limitations of the prior art and provides additional benefits. A brief summary of some embodiments and aspects of the invention are first presented. Some simplifications and omissions may be made in the following summary; the summary is intended to highlight and introduce some aspects of the disclosed embodiments, but not to limit the scope of the invention. Thereafter, a detailed description of illustrated embodiments is presented, which will permit one skilled in the relevant art to make and use aspects of the invention. One skilled in the relevant art can obtain a full appreciation of aspects of the invention from the subsequent detailed description, read together with the Figures, and from the claims (which follow the detailed description).

The inventor has noted that none of the existing electronic watermarks are designed to accept a third property (element), unlike the invention, as described herein. These third elements include digitized images (signatures and photographs), digitized bio feedback, bio prints, genetic prints, audio signatures, electronic signatures or digital spectrum signatures. The invention additionally sets itself apart from existing watermarking technologies in that it can establish conditions for accepting a third element. This includes business process rules, when, where, how, what, and why a content element gets signed. The invention allows watermarks to be made visible or invisible to the display or print out of the content elements.

The invention provides a means of capturing only one signature, along with other pertinent information and using it in conjunction with a “smart” watermark. The digitized signature is placed upon a “smart” watermark that determines if it is the correct signature. This does not require a learning algorithms and relies on only one signature sample. Digitized signatures are treated as images that can be electronically pasted into any document.

The invention allows the Public/Private Keys to interact with the smart watermarks to authenticate signers. No trusted third party is required for authentication. This technique described as an extension to existing Public/Private Key use is quite unique in that it provides a means of automatic authentication of documents, files without a trusted third party and establishes a new protocol for achieving execution of the authentication process.

Public Key Authentication can be used in conjunction with Message Authentication Code (MAC) to assure that the content elements have not been altered and that the issuer is who they say they are. This is accomplished by encrypting the documents hash count using the issuer's private key. The content element's receiving party can verify the MAC using the issuer's Public Key.

With the invention the issuer's private key and the signer's public key become elements in the smart watermark. Upon receiving a document to be signed, the signer can verify the issuer's MAC assuring them that the issuer sent the document and that the contents have not been altered. The signer then uses their private key to sign the content element and the issuer can verify the signer by using the signer's public key. This can be achieved automatically as a security protocol hand-shake between issuer and signer.

This process eliminates the trust third party authentication and the document can authenticate itself with or without the use of the issuer's server. In addition it establishes a new protocol for automatic authentication of database records, files and documents sent over networks, especially Internet. For this reason, this technology allows the authenticating security to stay with the document (or transfer object) and not the computer or with a trusted third party).

This invention may be used for attaching security to electronic documents and containment elements in such a way that the security remains with the document (or containment element) and not on the computers, networks or digital devices. The invention includes the concepts, ideas and implementation processes of applications involving dynamic watermarks, feedback watermarks, intelligent watermarks, document authentication, pre and post signing of documents, authentication of signer(s), creation of intelligent electronic signatures and their applications in electronic documents, seals, records, secure directories, electronic mail, electronic forms, electronic files, electronic labels, and all their associated printouts, duplications and transfers.

### BRIEF DESCRIPTION OF THE DRAWINGS

FIG. 1—Overview Concept of Invention

FIG. 2—Document & Signer Authentication with/and Between Each

FIG. 3—Printed Document Showing Watermark & Signature

FIG. 4—Creating a Signer's Profile

FIG. 5—Creating a Signer's Token

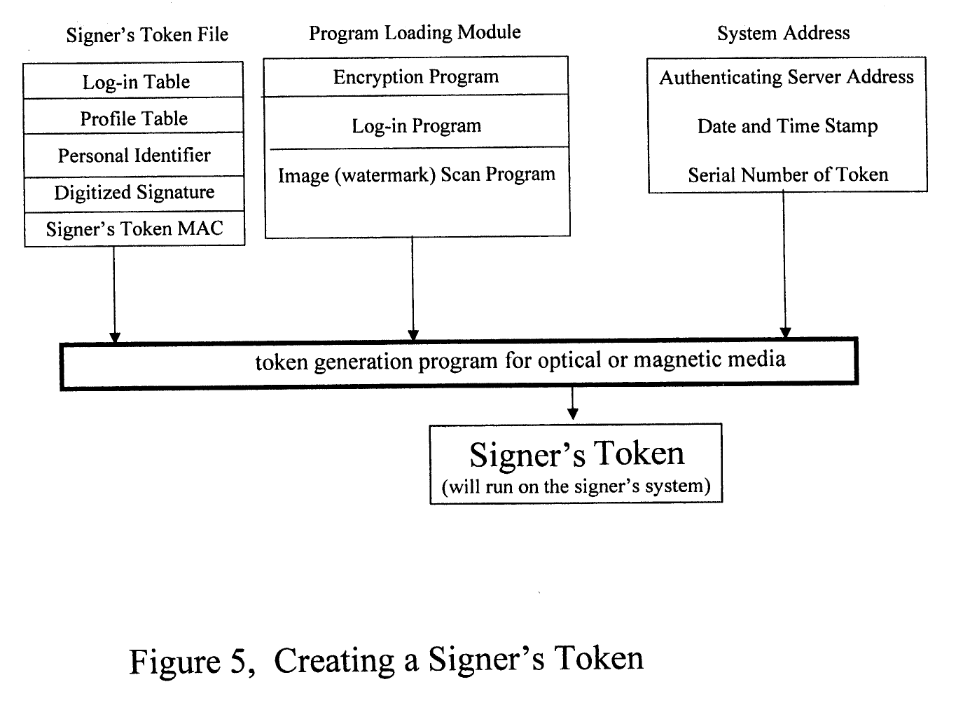

FIG. 6—Crating a Document's Profile

FIG. 7—Creating Watermarks for a Document and Signer(s)

FIG. 8—Signer's Token Log-in & Setup Process

FIG. 9—Overview of Signing a Document

FIG. 10—Verification of Signed Document

FIG. 11—Signature & Watermark Alignment Process

FIG. 12—Authentication without a Server

FIG. 13—Optional, Securing a Document Content Before Signing

FIG. 14—Securely Signed Document

FIG. 15—Electronically Exchanged Document

FIG. 16—Watermark Creation

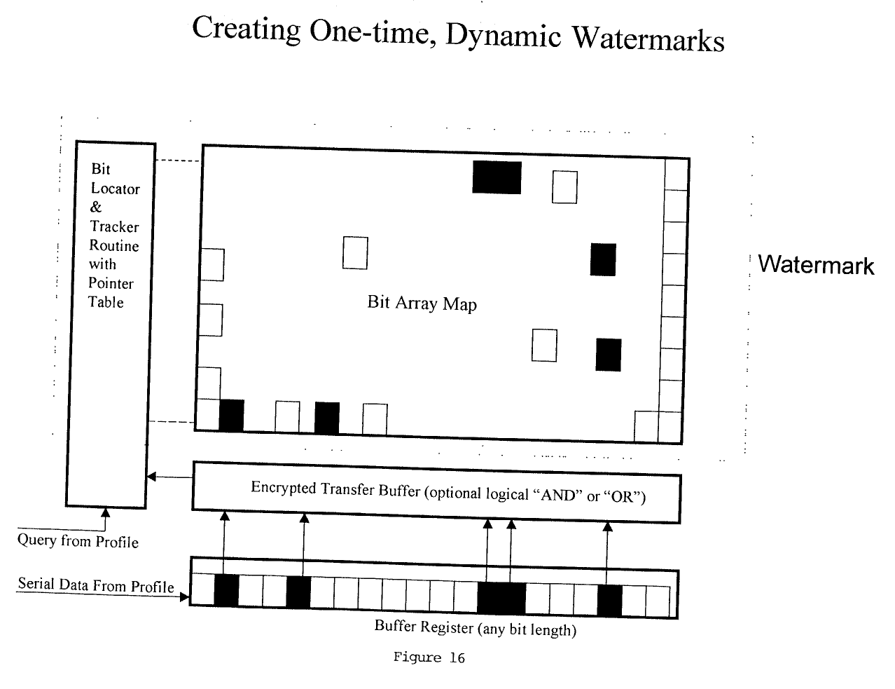

FIG. 17—Example of Bit Array Applied to Watermark

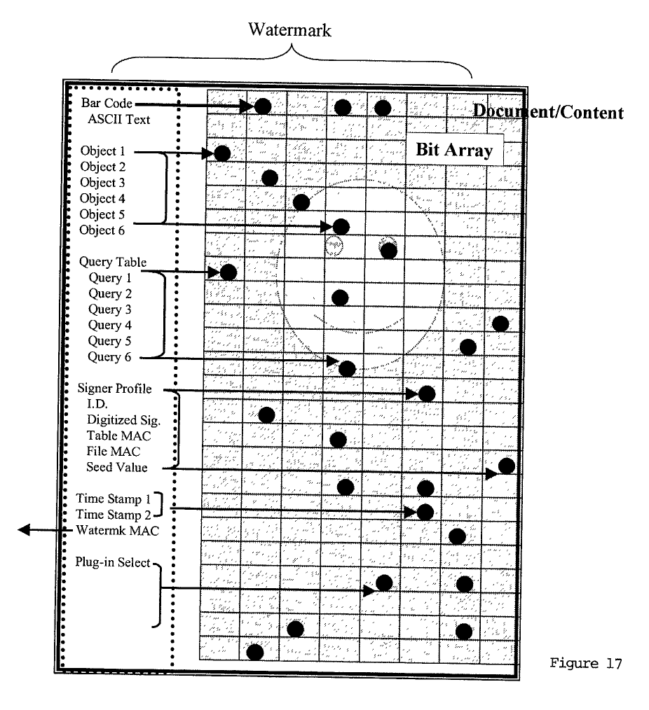

A portion of this disclosure contains material to which a claim for copyright is made. The copyright owner has no objection to the facsimile reproduction by anyone of the patent document or the patent disclosure (including Figures), as it appears in the Patent and Trademark Office patent file or records, but reserves all other copyright rights whatsoever.

The headings provided herein are for convenience only, and do not necessarily affect the scope or meaning of the claimed invention.

### DETAILED DESCRIPTION OF THE PREFERRED EMBODIMENT

The following description provides specific details for a thorough understanding of, and enabling description for, embodiments of the invention. However, one skilled in the art will understand that the invention may be practiced without these details. In other instances, well known structures and functions have not been shown or described in detail to avoid unnecessarily obscuring the description of the embodiments of the invention.

An aspect of the invention creates self-authenticating electronic documents and seals for any digital output of electronic text, images, vector plots, spectrum plots or database files requiring electronic signatures. Content elements are authenticated in pre-signing and post-signing modes using object information attached to the electronic content elements, containers, database records or secure directories.

Secure Object (SO) information attached to Content Elements (CE) allows the issuer of a CE to specify what, whom, how, when, where, and conditions under which a CE may be signed electronically. In addition a Smart Content Element ID (CID) is generated for an authorized signer of any CE. The CID is applied to the SO information attached to the CE resulting in a self-authenticating document or seal with a digital signature. The results is a “smart” document that mates with a “smart” signature that self-authenticates both the document, its contents and the signer without a trusted third party.

When the term “document” is used, it is defined to include seals, envelops, attachments (electronic mail), database records, forms and all versions of electronic files and associated extensions (such as .doc).

This technology defines, but is not limited to, the following as elements of the Secure Object (SO) used to create “smart” content elements:

What—is what is going to have authentication applied and is viewed at an electronic document, container such as an electronic envelope or box, or database file with or without a secure directory structure. The term content element is used as a description of “what” is being authenticated and signed.

Who—is defined as the authorized signer. The signer uses a “smart” personal identifier that qualifies what the signer's signature can be used for and identifies that content element or CE.

How—is the methods used in conjunction for signing document. This includes but is not limited to the following in combination with the signer's digitized signature:

Public/Private Key (PKI from existing key management schema)

Digitized audio prints that include but are not limited to voiceprints, acoustic prints, acoustic signatures, digitized electromagnetic signatures, spectrum prints, or signer profiling.

When—is the method of applying a time frame in which a content element must be signed.

Where—is the location at which a CE can be signed. This may be a physical location or a network address location. For physical locations GPS coordinates can be assigned to the object attached to the CE which the CID has to come up with as one condition for authenticating the signature.

Conditions—are a list of criteria required in the signing process. This is not limited to, but might include the CE distribution routing for sequential signatures.

In order to take full advantages of this technology as applied technology, additional processes may be used such as:

Encryption

Image Processing

Message Authentication Code

Audio Print

Digital Signatures

Digitizing Technology

Digital Signal Processing

Spectrum Signatures

Time and date stamp process

Topic Map (semantics—overlaid objects from eXtensible Markup Language)

These processes and their results are considered as “plug-in” elements that expand applied use of this patent for process functionality.

Scenario Applications

Creating and Issuing Watermarks and Digitized Signatures to be Applied to Documents

Creation of smart watermarks and digitized signature take place at the issuer's workstation. The smart watermark becomes an encrypted database file residing on the issuer's system and the smart digitized signature becomes password protected (see password generation section for security techniques used) encrypted object residing on portable electronic or optical media.

Watermarks are created based upon the Signer's profile information and Issuer's information and applied to tables that make up elements of the attached object code. The output of this object code, to display visual patterns of the watermark, may be digital spectrum plots of data, bar codes or images.

The issuer encrypts the smart watermark and archives it on his/her system., The signer leaves with a compact disk (CD), or magnetic medium containing a multiple password scheme, his/her digitized physical signature and a profile object making the signature a “smart” digitized signature.

This “smart” watermark will only accept signatures that are defined within the watermark. A “smart” digitized physical signature containing the signer's profile information and object is placed upon the watermark. These two elements qualify each other as the correct signature and watermark assigned for this specific signing session. If the two verify each other they are bound and secured onto the document using a MAC.

Applying Watermarks and Signatures to Vouchers

Vouchers very in types and are not limited to the examples used herein. For purposes of this example, the voucher is defined as a credit/debit account that is authorized by the holder but floats on a network or resides in a database. In essence it is an object that is controlled by the issuer but authorized by the signer and functions like a credit/debit card over a network.

Applying Watermarks and Signatures to Analytical Reports

Analytical instruments such as gas chromatographs, mass spectrometers and ultrasonic non-destructive testing equipment provide a print file of their spectrum signatures. These signatures can be turned into watermarks placed upon the report that authenticate the contents of the report and those signing it.

Applying Conditions to Watermarks and Signatures for Documents

One of the unique features of this technology is the ability to apply conditions that the signer must meet before signing can take place. This can be a document signature routing process, simultaneous routing signature process or that an on-line geopositioning device output location coordinates that are authenticated by the smart watermark as part of the signature qualification. Conditional information is structured as part of the object buried in the smart watermark.

Applying Watermarks and Signatures with additional Types of Signatures

Another unique feature this technology includes is the ability to combine a second signature element within the framework of the signer's profile. This includes, but is not limited to, the inclusion of voiceprints, audio clips, electromagnetic signatures, biofeedback signature and any other form of digital signatures. Another example would be placing an EKG into a patient's document as a watermark element. Other examples are adding smart watermarks on pharmaceutical prescription labels that authenticate doctors.

Additional signatures may include digitized photographs, retina scans, genetic prints, bio prints, digitized audio signatures, analytical instrument signatures, other forms of digital signatures (such as Public/Private Key) that identify individuals and processes.

Applying Watermarks and Signatures with Dynamic Feedback

By placing interactive table data within objects, the watermark can make conditional quarries about the signer's profile tables. Such quarries can seek and add data about the signer's computer, laptop, or handheld device. Such object routines may verify histograms and/or add data from the signer's system to his/her profile.

Applying Watermarks and Signatures to Database Records

Applying this technology to databases depends much upon the administrative security measures used on the database. The most direct approach is to append the user's secure directory service tables and incorporate the watermark as a function of record elements distributed to users. Watermark (hidden or visible) would be an element of the report generators authenticating content. Sign-off or modification of content by users would use their personal signature (digitized and profile) in the same way a document is signed. This is especially so with enterprise resource planning systems (ERP).

Authenticating a Signature on a Watermarked Document

There are two authentication processes that are available for authenticating the signer of a document. First is a manual authentication and the second is an automatic authentication. If the holder of a documents (content element) in printed form, need to authenticate the signer he/she will notice two message authentication codes (MAC) stamped in the margins of the document along with time stamps. One MAC is for the watermark and the other is for the signature. These MACs along with the serial number of the document are input into issuers watermark routine which generates the MACs independently and these MAC match the MACs shown on the document, then the signature is a correct signature for that document.

Remote and Mobile Signature Authentication

Documents or forms (content elements) can be downloaded into remote computers, laptops computer or handheld devices. These downloaded documents contain watermarks that profile the signer. The signer has an initial temporary profile built via the web site and uses a digitizing device to capture his/her signature. This signature is witness by the issuer's agent at which time a registration routine is requested from the website. The web server generates a one-time password and transfers that password to the signer's cell phone, pager or handheld device. The signer then enters this password via the issuer's web page and the web server accepts the transfer of the signed documents (done by file transfer protocol or email). The signed document may reside on the agent's computer (laptop, computer or handheld device) and transferred later to the issuer's system.

Use of the described dynamic password process creates a phone log and audit trail that the correct password was received by the signer and entered into the system. The dynamic password is tagged to the signer's record as well as the phone number (or network address) along with the date and time stamp of the transaction.

Issuing Watermarks and Signatures via Wireless Networks

This process is the same as the Remote and Mobile Signature Authentication application described above only it tags the watermark and signature along with the session information to the application file structure. The file structures typically included, but are not limited to, all of today's application files including .pdf and other image or vector image files.

Topic Map

Topic Mapping applies to the use of extensible Markup Language (XML) and sets up the semantics for XML data used within documents. This is especially meaningful in translating data between Electronic Data Interchange (EDI) and XML. Topic Maps can be added to XML documents as object overlays. An aspect of the invention provides for the ability to use Topic Maps as dynamic watermarks or part of watermarks for documents.

Even though a signature may appear on a electronic document (printed or not) does not mean that that signature is valid. Using editing tools, one can cut and paste signature images into most documents. It become necessary for there to be a secure means of linking and electronic signature to a document, and its contents, in a way that it can not be extracted for other purposes. This is what the “Applied Physical Electronic Signature” does. It allows physical signature to be applied to electronic documents dynamically and in an interactive mode by users. Physical signatures can now be applied to Internet/Internet browsers based forms, browser documents, electronic files, electronic folders, and electronic containers, drawings and images that are exchanged over networks.

Present authentication techniques over networks, especially Internet are very much dependent upon the use of “trusted” third parties to authenticate. With an aspect of the invention, trust elements are built into content elements (electronic documents, containers and files) in such a way that the “trust” element travels with the document. In addition, the two components of this trust element (watermark and digitized signature) define and authenticate the signer(s). The trust element is embedded into the content element and may not be detached unless the content element is altered or destroyed.

In creating the trust element an audit trail is pre-defined and the authentication process becomes a means of verifying the content element (document) and/or its signer. The trust element becomes the agent of the document. This agent becomes an integral part of the document so that a document security does not reside in the computer, network or digital device.

One existing problem for Public Key Infrastructure associated with digital certificates and digital signatures over networks is providing an audit trail without a trusted third party. The reason is that PKI requires action by receiving party to verify the sending party's certificate or signature. Also, the receiving party may not be aware of the type of action he/she to take such as looking at the properties of the sending party's digital certificate. PKI audit trails exist with the third party as the authenticating agent.

Much of the detailed description provided herein is explicitly disclosed in the provisional patent application noted above, or in U.S. provisional patent application No. 60/262,335, (attorney docket number 34323-8002US) filed Jan. 17, 2001 (entitled Document Security System), and ______ (attorney docket number 34323-8002US01), filed Feb. 28, 2001 (entitled Physical and Electronic Security System, Such as For Documents), all naming Robert Smith as an inventor and being assigned to the same assignee. Most or all of the additional material of aspects of the invention will be recognized by those skilled in the relevant art as being inherent in the detailed description provided in such provisional patent applications, or well known to those skilled in the relevant art. Those skilled in the relevant art can implement aspects of the invention based on the detailed description provided in the provisional patent applications.

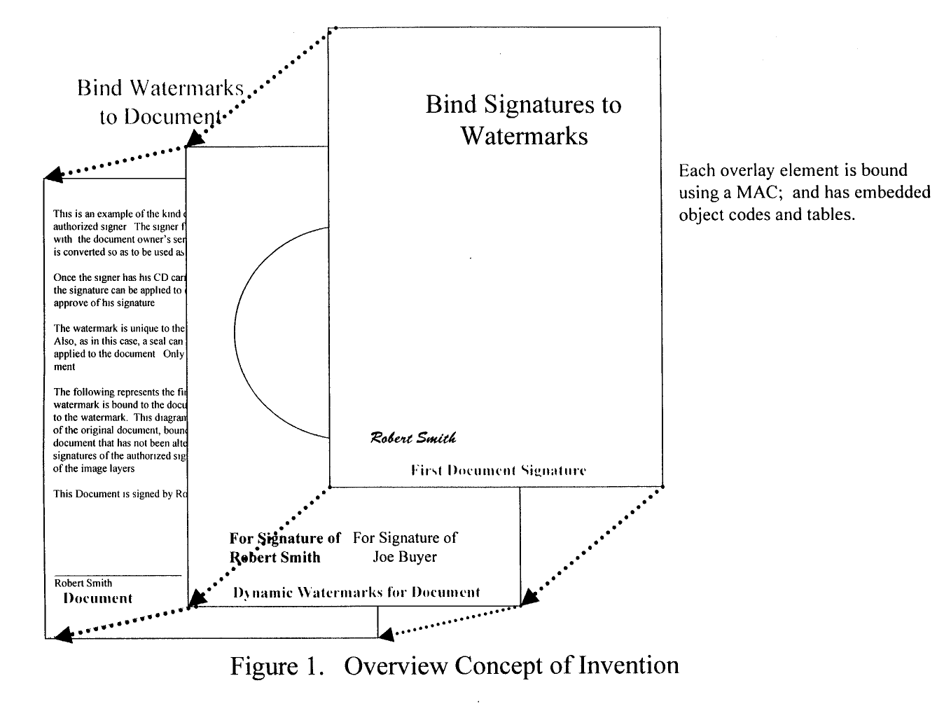

FIG. 1. Overview Concepts

FIG. 1 depicts the layers involved to bind watermarks and signatures to document. Each layer becomes bound by using a MAC (encrypted hash count of combined layers). The dynamic watermark is a uniquely generated watermark for each document and each signer. The watermarks contain information and objects that define who, how, what, when and where a document can be signed. The objects contained in the watermark set up conditions for signing such as, but not limited to, order of signatures or distribution of the document.

The signature layer includes a digitized signature or combination of types of signature (digitized physical signature plus voice print or biometrics signature). In addition it contains embedded tables of encrypted data concerning the signer.

When the watermark is generated in consist of multiple segments (consisting of spectrum images and 2D bar codes). The image represents the document profile. 2D bar code is used to form the pointer table, watermarked document MAC and the MAC of the signer's profile value as selected by the pointer table.

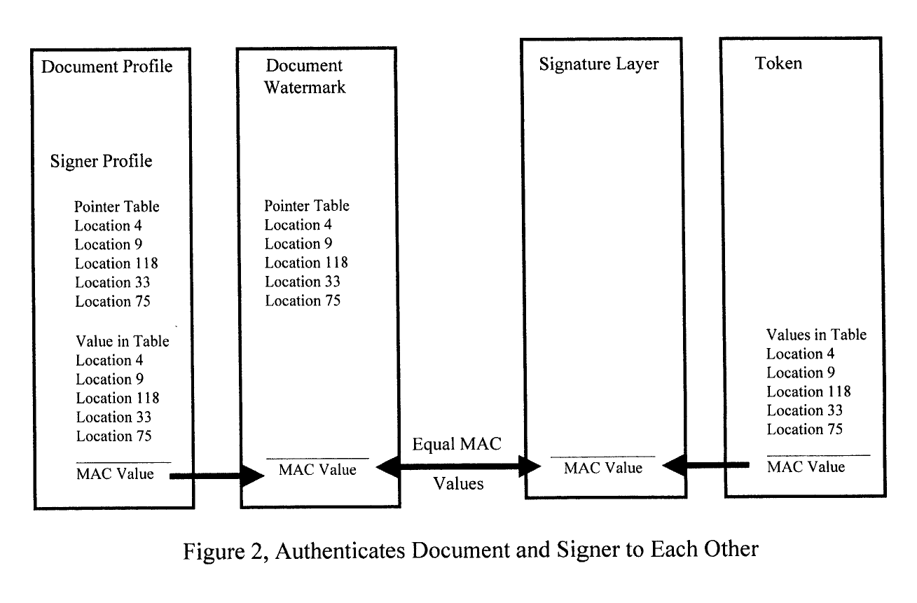

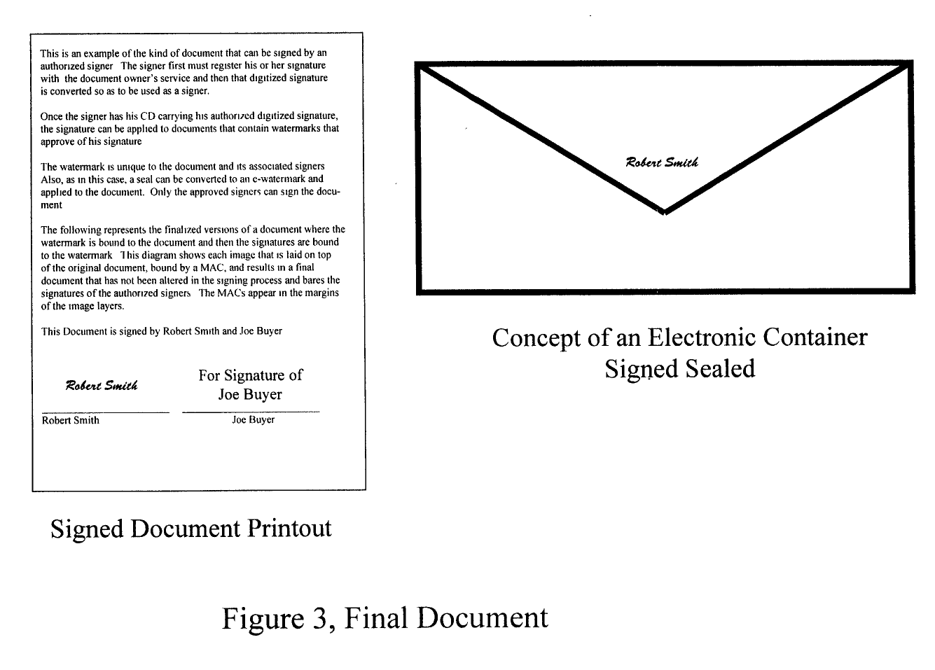

The signer's system selects the values requested from the watermark pointer table and performs a MAC using MAC Key 2. If the MACs equal then the document is the correct document for the signer to sign and the signer is the correct signer for the document. An automatic merge takes place and the signer's layer is bound to the document. A serial number extension is generated from the summed MAC of all layers and the authentication is complete. See FIG. 2 showing the pointer tables and the authentication process. FIG. 3 shows the results as a printed out document as well as the concept of a sealed container.

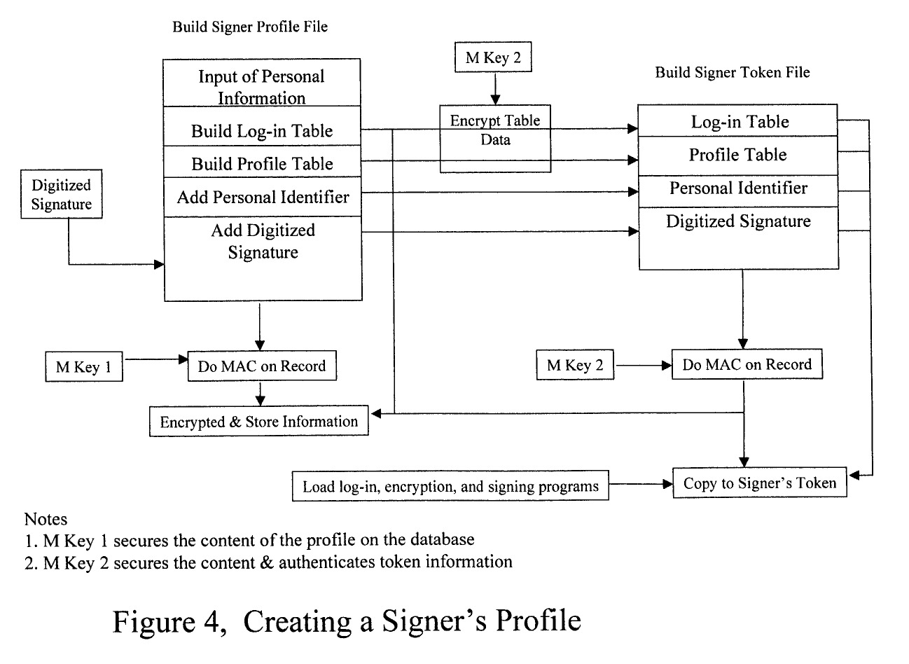

FIG. 4. Creating a Signer's Profile

FIG. 4 shows the supporting process required to generate a signer's profile. Collecting and imputing information about the signer is basically unlimited (the more unique information the more secure). Profile information should be hardware encrypted in the database. This information is used to generate a User Profile Table (UPT) which is in turned used to generate a log-in process and pointer tables (which will go into document watermarks).

Building a Log-in Process

Log-in Process Description

For an aspect of the invention we have selected a multi-level log-in process although it is not limited to this log-in example. As part of this invention we are using a combination of log-in and dynamic password which is part of the signer's profile and table pointers described above. The high-level log-in uses signer's identification and assigned password established on their token (CD or magnetic media). Once the initial log-in is completed, one or more random points are made to the signer's profile table creating a query that the signer must answer. The answer hash is totaled and encrypted using MAC Key 2. This resulting value must match the MAC sent in the Watermark. If it equals the same value then the log-in is correct and the signer is prompted to proceed to the next level.

Building the Log-in Table

Building the Log-in Table requires information that only the signer knows and not the normal information in the Signer's Profile Table. As the Log-in Table is built information is encrypted under MAC Key 2 (which is the MAC of the sum of data in the Signer's Profile Table). Only the encrypted value is used to authenticate and not the actual information.

Adding the Personal Identifier

After the Signer's Profile Table and Log-in Table have been created, a Personal Identifier is Created. Any method will work but it is recommended that what is tagged to the database file of the Signer's Profile Table be encrypted (under M Key 2) and tagged onto the Signer's Profile Table (not included in hash count though) and used to transfer to the Signer's Token. This reduces the risk of clear text record identification getting into unfriendly hands therefore minimizing the risk to the central database.

Adding Digitized Signature

Digitized signature of the signer can be captured via a digitizing device (pen or pad) or by a scanner. If a scanner is used the background must be converted to a true negative of the signature. This is stored as a bit map image and is included in the record (Signer's Profile Table) hash count for performing a MAC on the record.

Building the Signer's Token File

The signer's token file is the file we write to electronic or optical media and is given to the signer to use with his/her computer or digital device. It consists of the signer's log-in table (encrypted under M Key 2), profile table (encrypted under M Key 2), personal identifier (clear text), and digitized signature (bit map). A MAC is generated with M Key 2 using the sum hash of these elements. This signer's token MAC is handed back to the signer's profile file (which stores MAC1 and MAC2 for future verification if needed. FIG. represents the final steps in creating the signer's token.

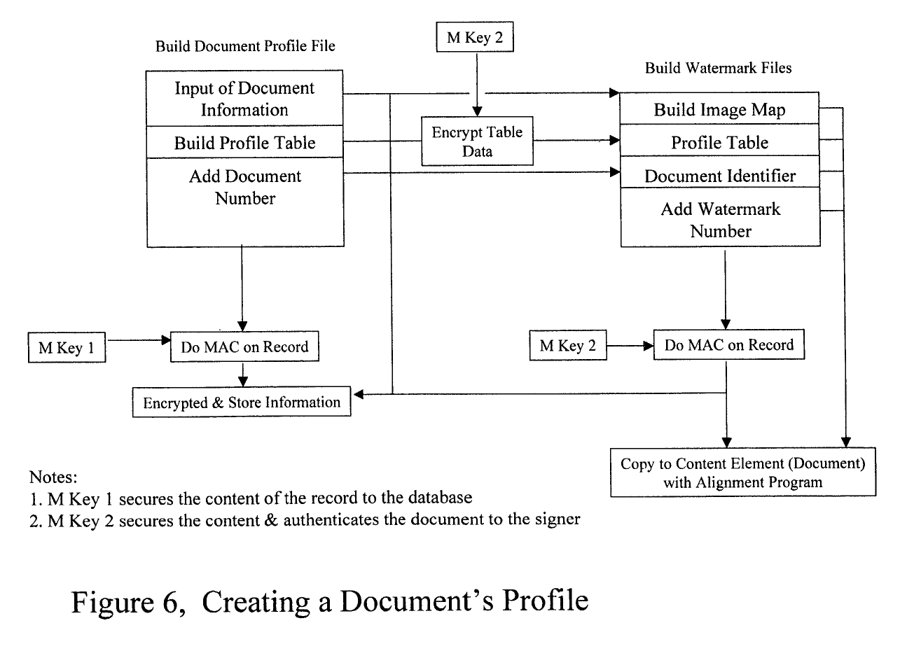

FIG. 6. Creating a Document Profile

Creating a document profile is essential in setting up the electronic document (container) authentication with the signer and authenticating the signer. It provides intelligence about who, what, when, why, how and the conditions for which the document is signed. In addition, contents of the file include a template image bit map developed specifically for the document. The image bit map template can be a company logo, an output from a digital device or instrument as a spectrum plot, digitized photograph or digital signature. In addition to the bit map template, information can be stored in bar code (recommend PDF 417) or a combination of both.

A bit map image template is a base image that can be modified by adding or subtracting bits (using vector plots of information values from the profile table). Adding and subtracting bit in various locations within the image changes the MAC value of the image; resulting in unique MACs for each document image. These images are filtered to create visible or invisible watermarks when printed out.

Once the watermark image has been formed it is assigned a number (optional serial number) that accompanies the document. The watermark for the document and the watermark for the signer's profile pointer table are MACed (using M Key 2) and printed in the document margins as extensions to the document's serial number. This makes each document unique to each signer; each with a serial number that can be traced. The system as well as the signer's system can store the serial number of the watermarked document.

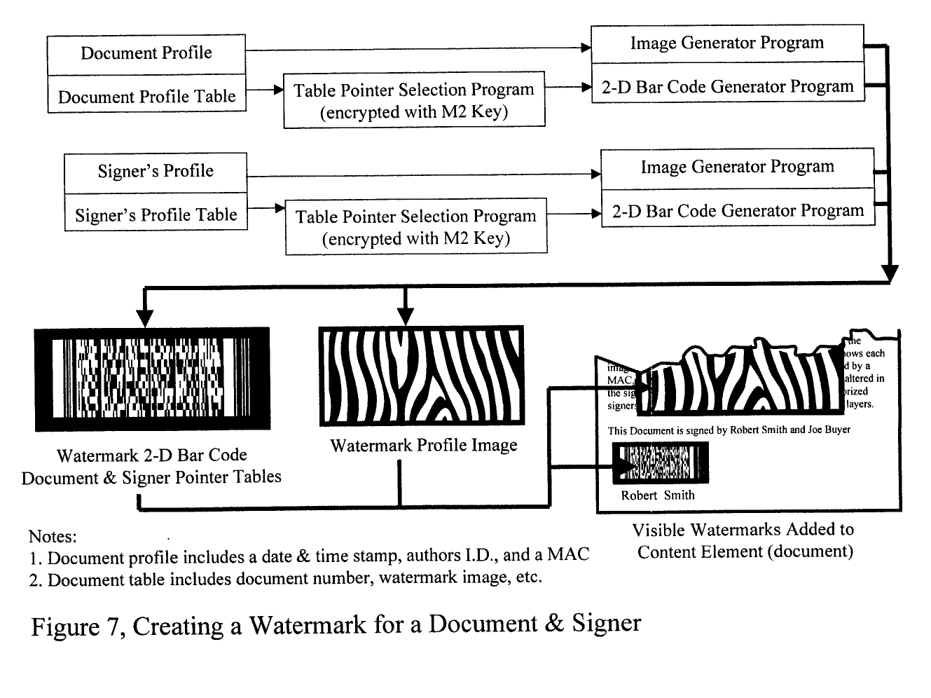

All watermarks are date and time stamped as part of the authoring and signing process. FIG. 7 shows additional details in the process of creating watermarks for documents and signers.

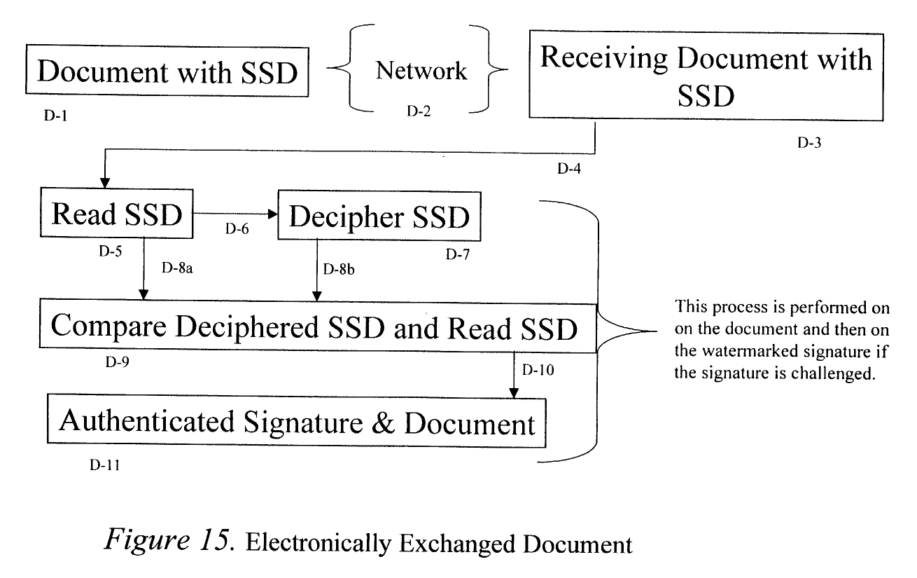

FIG. 15 shows creating the one-time, dynamic watermark using a bit array map. The Bit Array secret is knowing where to start and stop in the array in order to build an encryption or MAC key.

Serial Data Input to Buffer Register: Data is transferred from the answers in the User and/or document profile. This information is then transferred to a transfer buffer where the data can be optionally manipulated with and/or encrypted with M1 Key. The bit structure output goes to a bit array map which is the dominate image overlaid onto an image bitmap (seal, photo or image like a logo).

The Bit Array Map output is a group of set bits located within an array that correspond to queries setup by the profile. Query data is then sent to the locator object routine that notes the location of an important bit and what it means relative to the query. This bit arrangement may also relate to tabular data as a set bit to trigger other objects or provide true/false logical settings. ASCII data stored within the Bit Locator & Tracking Routine as well as the tabular data are converted to 2D bar code and appear as bar code readable portions of the water mark. A watermark may contain any number of Bit Locator & Tracking Routines. One main function of the Bit Locator and Pointer Table portion of this object is the Signer's Profile digitized signature coordinates and geographic form factors. This allows the signature to only be applied to specific locations within the watermark.

The Bit Array Map may have a lock such that if the Bit Locator & Tracking object has been compromised, the intruder is still unaware of where the start and stop bit originate. This is control by the one-time plug-in generated under M2 that has a time stamp applied. FIG. 18 shows an example of a bit array applied to a watermark, where individual bits or cells in an 8 by 24 overlaid array represent particular user information, including responses to user specific queries 1-6 (that may be responses to such questions as “what is your oldest son's age?”.

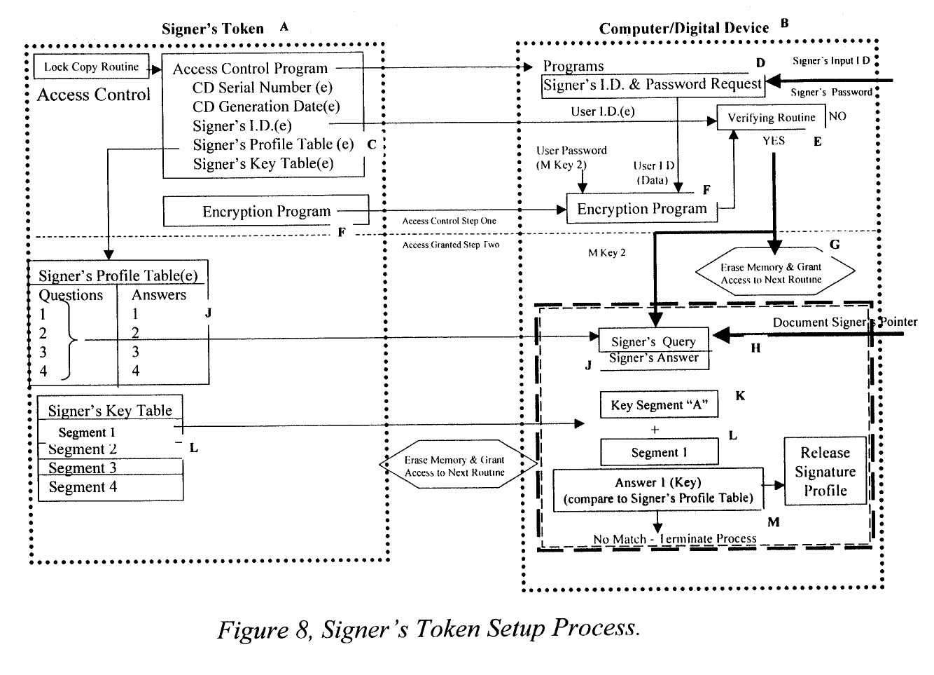

FIG. 8 Signer's Log-in & Token and Use Process

Item “A” show the elements contained on the Signer's Token. A token can be any media that stores data that can be loaded into a remote or mobile device. For purposes described herein we use a compact disk (CD) but the token can be a “smart” card, magnetic disk, network, or handheld devices.

Item “B” is the Signer's processing unit considered to be a laptop computer, desktop computer or handheld computing device.

The following setup process uses a CD and desktop computer as examples in describing how an aspect of the invention's signer's log-in and token setup process occurs.

Access Control

Access to the signer's token is a crucial security element to maintain the integrity of the system. Although several approaches work, the principle behind access control is that the token contains information known about the signer but is not revealed to the signer in any way. All information on the token should be encrypted under M Key 2 (defined earlier). For this reason, the token should automatically boot-up the log-on application programs contained on it and have the log-in process be composed of several segments that depend on each others results. This may be employed using the following steps:

1. CD token boots up and loads the following programs into the signer's PC (D).

encryption program

high level log-in with signer's I.D. and Password

2. Signer enters his/her I.D. and Password, if this is correct (E) the program prompts the next level of log-on and load in M Key 2 into an indirect address location in memory

3. Load a predefined number of questions into the signer's PC and prompt the signer to answer them (C & J)

4. Encrypt signer's answers under M Key 2, request question pointer and use to point to encrypted answers residing on token, if the encrypted answers match those in the token table (M), generate a key segment and temporarily store it in a memory buffer on the PC (K).

5. Erase memory and . . . .

6. Load first key from Signer's Key Table (L) and combine it with the keg segment stored in temporary buffer (K). This now is the one-time key to decipher the signer's digitized signature residing on the token. These two segments can now be stored and used to sign the first document.

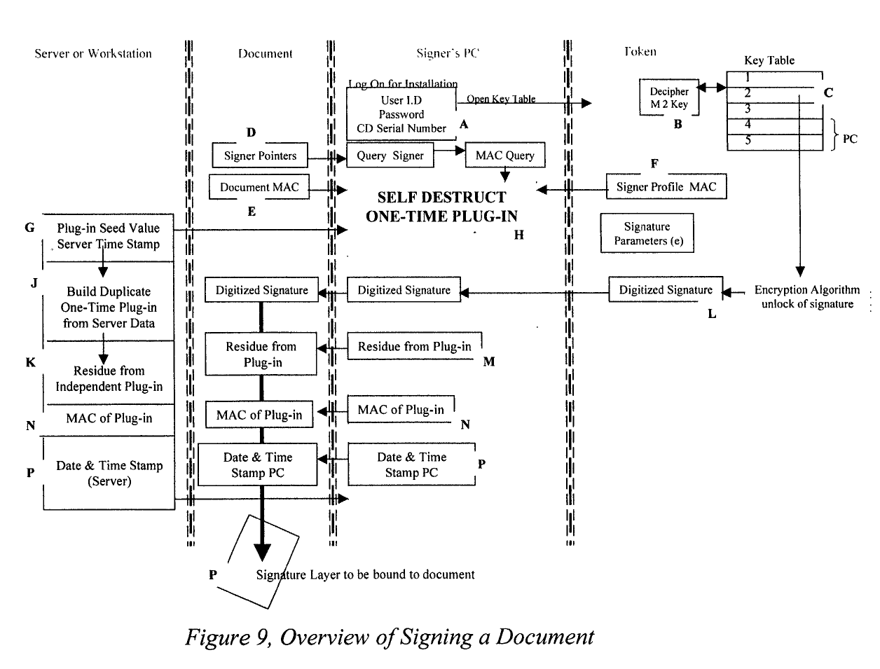

FIG. 9. Overview of Signing a Document

FIG. 9 shows the entire process of watermark creation through signing. The following describes the interaction of process elements with aspects of the invention components:

(A) Log-in Process

Authenticating the Document for the Signer as a Valid Document

The User log-in can very based upon application and level of security needed. As part of this invention process the goal is to insert a dynamic password component. Using normal log-in with User Identification and Password, M1 Key is used to decipher one or more questions (selected by the signer's pointer table on the document noted as “D”) residing on the token. A MAC is performed on the signer's answers. This MAC is compared to the signer's MAC on the document and if the two matches, the signer is assured this document is a valid document for signature.

Authenticating the Signer to Further Token Profile Information

Up to now, the signer has completed a high-level log-in and has authenticated the document as a valid document. Next the signer needs to be further authenticated to additional profile information. This is accomplished by having the signer's MAC (mentioned above) added to the seed value (G). This seed value is added to the key selected from the key table and the combination becomes the encryption key use to unlock the signer's digitized signature “L”.

Building a One-time Plug-in

The One-time Plug-in (H) generates unique elements to the signer's signature that can only be regenerated by the server. The Plug-in is composed of interrupt driven loaders (Seed Values “G”) from the server in combination with embedded objects from the server. In addition a digitized image of the signer's signature is loaded (L), residue from the plug-in is used (M), a date and time stamp is applied (P), and a MAC (using M Key 2) is performed upon the data. Elements L, M, N and P are stamped onto the signer's layer of the document.

Date and Time Stamp

Two “Date and Time Stamps” (P) exist but are different. The stamp from the server is created at the time the build a duplicate plug-in (based upon the time zone of the signer). This stamp is transferred to the signer's plug-in. The signer's plug-in uses the stamp from his/her computer. The difference between the two time stamps is the time allowed for the signature process to be completed. If it is not executed within a predefined time frame the process is aborted.

Output to the Document

Elements L, M, N and P are stamped onto the signer's layer of the document. An alignment program is used to align the margins of the signer's layer to the document and watermark layers. In addition, the alignment program skews the signer's image signature with the seed value to create a unique on-time version of the signer's signature (for visible signature on display or printout).

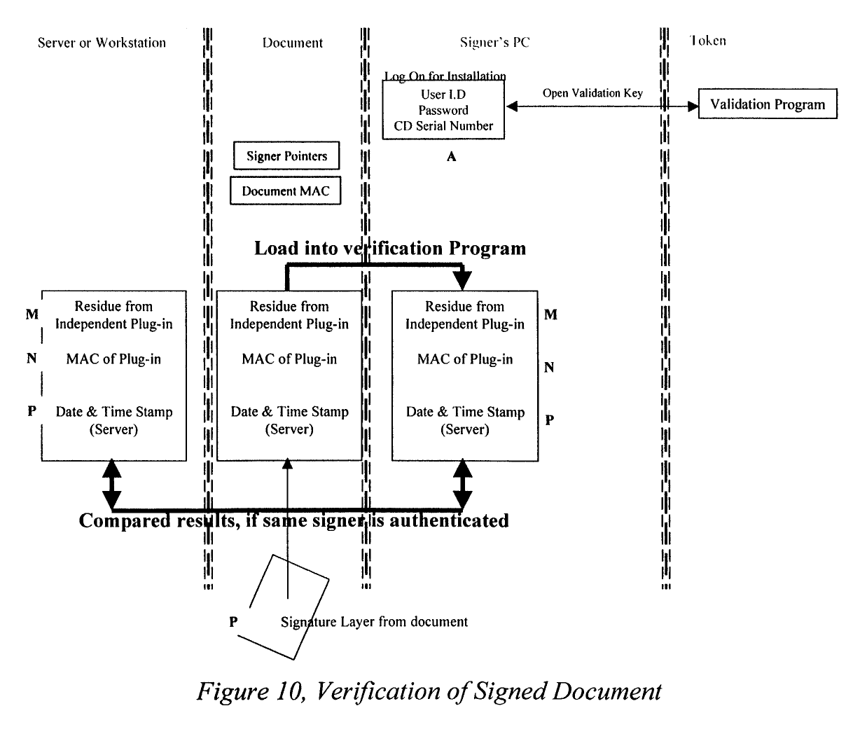

FIG. 10, Verification of a Signed Document

Log-in for Verification

A log-in verification is not necessary but recommended in order to audit activity surrounding a document. The log-in routines allow the verifying agent to log-in and select a document based upon its serial number. Once selected, the verification routine is initiated. We are using the same process established for the signer of a document in that the signer must have a token as part of the log-in process. When the log-in is completed the document with the proper serial number is transferred from the server.

Verifying a Document to the Verifying Agent

The document contains M, N and P authentication elements. “M” is residue from the One-time Plug-in that has been bound to the document (visible or invisible). The MAC is recalculated from “M” using M Key 2 and if the results match that that is found on the document, then the document is authentic.

Verifying the Signer of the Document to the Document

On the server side M, N and P elements were stored along with the document and its layers. If these elements match those on the serial numbered document, then the signature is correct.

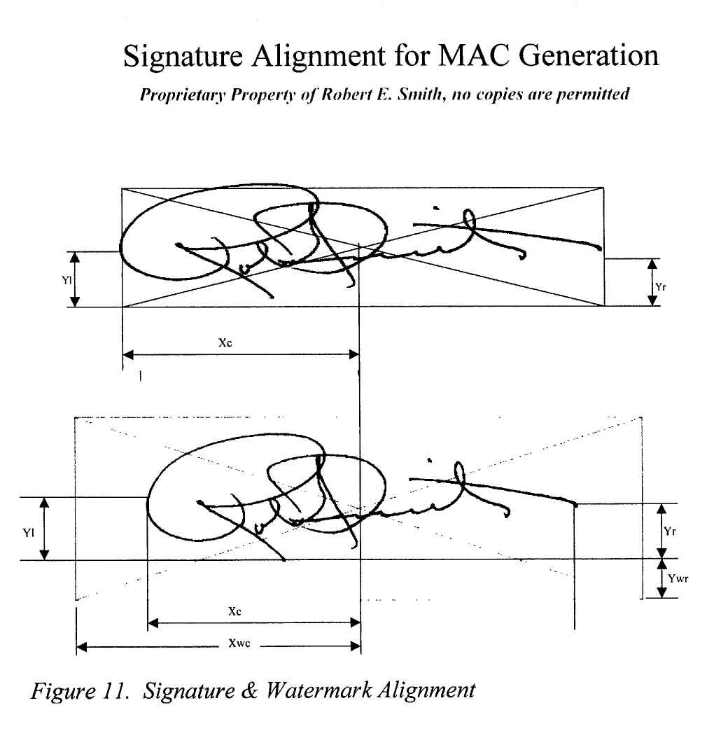

FIG. 11, Signature & Alignment for MAC Generation

In order to generate consistent signature MACs, an alignment process needs to take place with the signature on the watermark. Watermarks for signatures are designed to fit in the signature block area on documents and therefore are rectangular. This allows for coordinates to be assigned for dimensions as noted in FIG. 11 as Xwc Ywl (Y coordinate watermark left) and Ywr (Y coordinate watermark right). Likewise the signatures have coordinates shown as Yl, Yr and Xc. Each diagonal of the coordinates cross at a center point and the two center points must come together and then be aligned with X and Y coordinate slopes. In order to keep the correct MAC the signature image must be centered on the watermark's center and aligned at the same angles on the x and y coordinates.

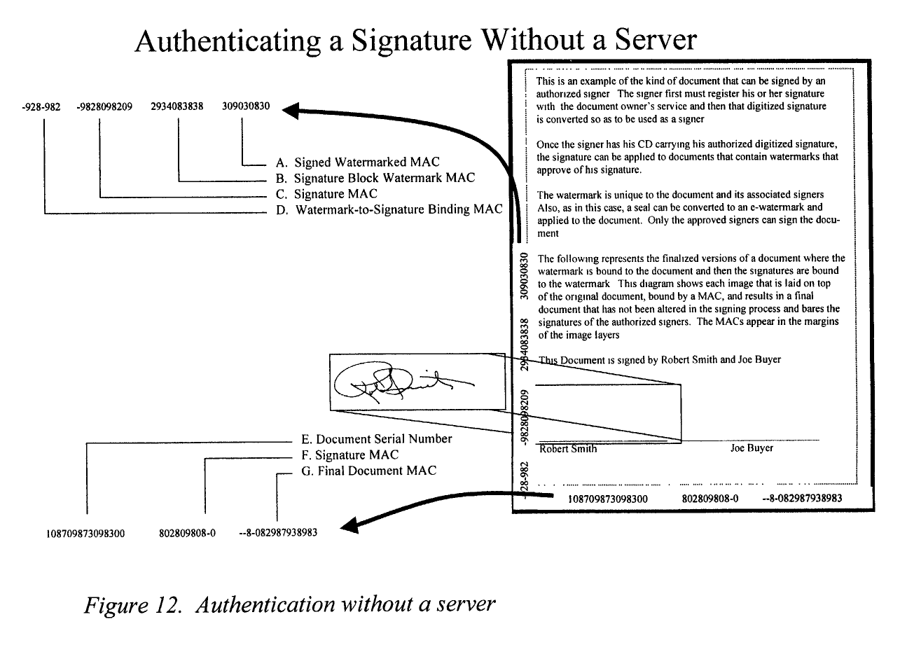

FIG. 12. Authentication without a Server

Document serial numbers and MACs are printed in all document margins for the purpose of allowing authentication to take place without a network or system. This allows printed documents to be manually authenticated. All documents are archived by serial number. Authentication can occur two ways. First a user provide an administrator with the documents serial numbers. If all the numbers in the margins match with that on file, then it is an authentic document with an approved signature.

Second, if a more detailed authentication check needs to be performed then an administrator can but in the raw MAC values and have the server recalculate the archived document MAC. If the two MACs are the same then the document is authentic as well as the signature.

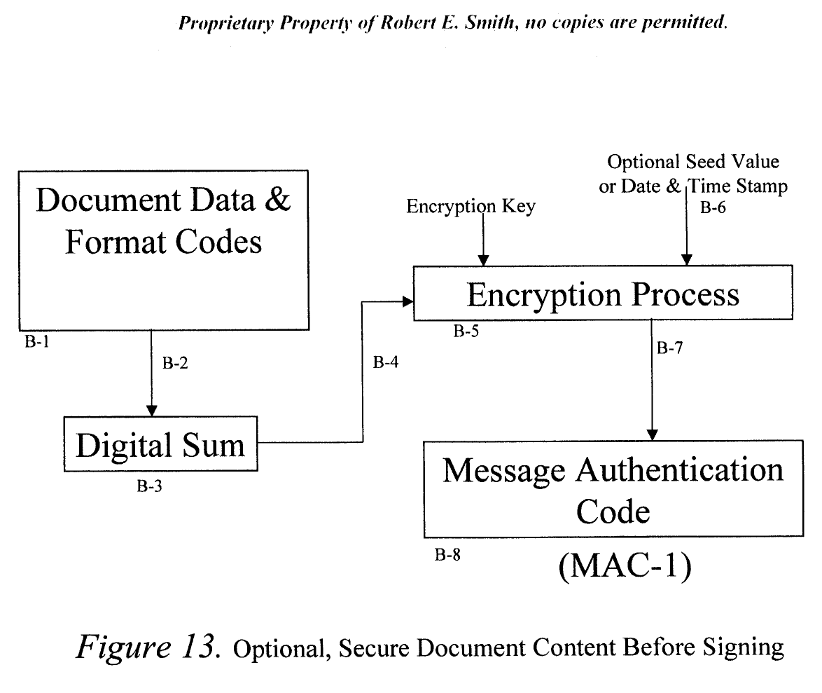

FIG. 13. Optional, Secure document Content before Signing

FIG. 13, details an optional process which might be desired if proof of a document content is needed before signing. A hash or digital sum (B-3) via (B-2) from the document, which includes data and format codes (B-1), are generated as data input which is transferred via (B-4) to the encryption process (B-5).

The encryption process (B-5) uses an encryption key (from the user's database) and an optional seed value (which can be a time and date value). The output of the encryption process is via B-7 and is the Message Authentication Code or MAC-1.

The document MAC may be placed in the User's database record along with the document. This value, if stored with the date and time would authenticate the content of the document before it was signed.

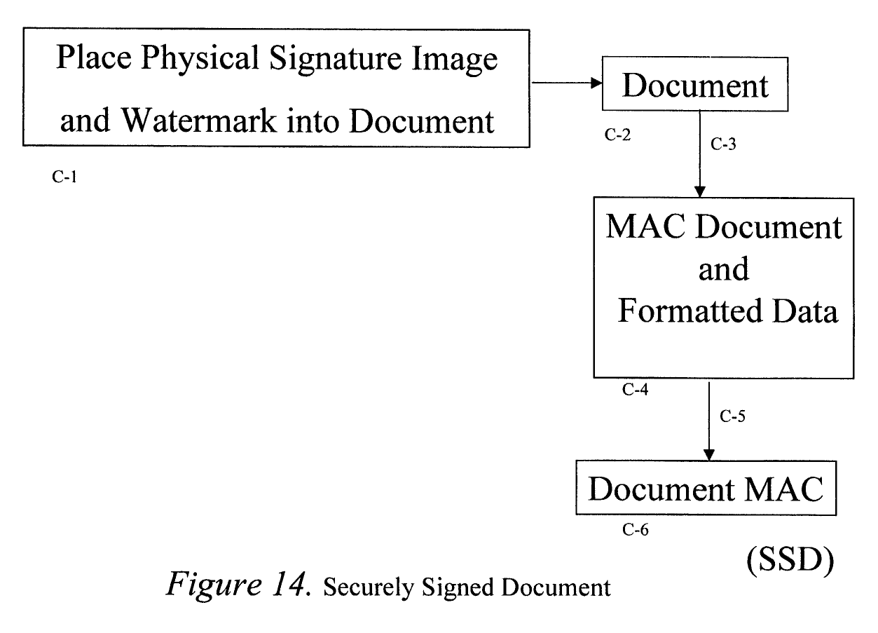

FIG. 14, Securely Signed Document

FIG. 14, describes how a watermarked physical signature is secured to a document or form and securing the content of the document or form against alteration. The result is a securely signed document that can not be altered.

The physical signature image and the watermark are combined (C-1) and attached to the document (via cut and paste techniques on the computer). The complete document (C-2) data with formatting codes is sent as a data stream (C-3) to an Message Authentication Code (C-4) MAC process as described in FIG. 2.(This is a standard encryption process that takes the hash or digital signature of the form or document and runs that through an encryption process). The MAC is then attached to the document's electronic header (C-6) via the transfer C-5. This is now an electronic document that is a Securely Signed Document (SSD)

FIG. 15, “Electronically Exchanged Documents,”

FIG. 15, depicts sending and receiving a Securely Signed Document (SSD) over a network. A document with SSD (D-1) is sent over the network (D-2) and D-3 is the receiving party. The receiving party reads stores the Message Authentication Code (MAC) header on the electronic document and (D-5) and calculates and independent MAC (D-7). Read SSD (D-5) transfers it value to D-9 via D-8a and the new calculated MAC from the Deciphered SSD (D-7) is transferred to D-9 via D-8b, where two MACs are compared. If they match then the contents of the forms or documents have not been changed. If they do not match in D-9 then document tampering has occurred.

Once this process has authenticated document then the process may be repeated only using the MAC from the signature on the document.

Authenticating the signature can have more than one type of approach. The first is calculating the MAC from the watermark signature on the document but in some instances the watermark itself may need to be authenticated. In order to do this the receiving party will store the date and time stamp from the document, the MAC code on the watermarked signature, have the encryption keys for the MAC.

Deciphering the MAC (when no seed value is used) with the encryption keys will yield the hash of the watermark. This hash value is checked against what resides in the sender's database and can be treated as a User Identification Number.

In user applications the watermarked signature may be “hot-linked” in the document to the watermark archive database.

In the case were a seed value is used the watermark hash is used as a known value and is verified in a database while the seed value is actually calculated and compared with what resides the User's database archive.

Public Key Infrastructure (PKI) may be used for Message Authentication Code encryption processes as part of the key management system.

Encryption algorithms that allow for seed value inputs provide further authentication options for users.

As noted above, one of the most difficult problems in establishing and maintaining digital certificates and digital signatures over networks is that of providing an audit trail of the actions of the receiving party to verify the sending party's certificate or signature. Also, the receiving party may not be aware of the type of action he/she to take such as looking at the properties of the sending party's digital certificate.

Although not required, embodiments of the invention are be described in the general context of computer-executable instructions, such as routines executed by a general purpose computer, e.g., a server or personal computer. Those skilled in the relevant art will appreciate that aspects of the invention can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. Aspects of the invention can be embodied in a special purpose computer or data processor that is specifically programmed, configured or constructed to perform one or more of the computer-executable instructions explained in detail below. Indeed, the term “computer”, as used generally herein, refers to any of the above devices, as well as any data processor.

Aspects of the invention can also be practiced in distributed computing environments, where certain tasks or modules are performed by remote processing devices, which are linked through a communications network, such as a Local Area Network (“LAN”), Wide Area Network (“WAN”) or the Internet. In a distributed computing environment, program modules or sub-routines may be located in both local and remote memory storage devices. Aspects of the invention described herein may be stored or distributed on computer-readable media, including magnetic and optically readable and removable computer discs, as well as distributed electronically over the Internet or over other networks (including wireless networks). Those skilled in the relevant art will recognize that portions of the invention reside on a server computer, while corresponding portions reside on a client computer. Data structures and transmission of data particular to aspects of the invention are also encompassed within the scope of the invention.

Various communication channels may be used such as a local area network, wide area network, or a point-to-point dial-up connection instead of the Internet. The server system may comprise any combination of hardware or software that can support these concepts. In particular, a web server may actually include multiple computers. A client system may comprise any combination of hardware and software that interacts with the server system. The client systems may include television-based systems, Internet appliances and various other consumer products through which auctions may be conducted, such as wireless computers (palm-based, wearable, mobile phones, etc.). Moreover, the concepts of the present invention may be applied to system that are not entirely supported by computer systems.

The technology defines a new type of watermark and electronic signature technology that can be applied to content elements (documents, seals, electronic containers and database records). The resulting application uses include a means of authenticating content elements prior to applying an electronic signature as well as after applying signatures. This is achieved with or without the use of third parties based upon user's options.

This watermark and signature technology may be visible or invisible to the document or content element and authenticates the signer to the content element.

Specifically this technology provides a method of creating and applying a “smart” watermarks or seals to electronic documents, electronic containers or database records that identifies:

1. the “to-be” signer based upon information about the signer;

2. the criteria about which the signer can sign such instrument such as but not limited to:

signing limits

signer's profile data

time limit applied to the document for signatures

number of signatures and order of signing

location of signing

3. the criteria about the document such as but not limited to:

serial number of content elements;

bar codes applied to content elements;

content element routing rules;

length of time the content element can circulate;

program object codes links as a condition of signing the content element;

embedded codes and tables associated with the content element;

time and date stamps;

the application of authentication codes or hash marks.

The invention includes a method of applying a digitized signature or digital signature to electronic documents, containers or database records that are using “smart” watermarks or seals for the purposes of:

transferring liabilities;

authenticating content source;

authority acknowledgement of approvals, exchanges or transfers;

authorizing transactions;

authenticating content pre and post signing.

The invention includes a method of authenticating “smart” watermarks, seals, digitized physical signature or electronic signature used singularly or collectively on documents, containers and database records.

The invention includes a method of executing a transaction by transferring authenticated information having a verifiable evidence or audit trail.

The invention also includes a method of inclusion of watermarked signatures within applications such as but not limited to:

1. Word processors

2. Spreadsheets

3. Images

4. Technical engineering drawings (CAD)

5. Adobe Acrobat files

6. Mail

7. Plain text messages

8. Audio files or acoustic information

The invention further includes a method of inclusion within families of scripting languages such as Java, ActiveX, XML, and CGI.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein, above,” “below,” and words of similar import, when used in this application, shall refer to this application as a whole, and not to any particular portions of this application.

The above description of illustrated embodiments of the invention is not intended to be exhaustive or to limit the invention to the precise form disclosed. While specific embodiments of, and examples for, the invention are described herein for illustrative purposes, various equivalent modifications are possible within the scope of the invention, as those skilled in the relevant art will recognize. The teachings of the invention provided herein can be applied to other security systems, not necessarily for the document security system generally described above. The elements and acts of the various embodiments described above can be combined to provide further embodiments.

All of the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, in the following claims, the terms used should not be construed to limit the invention to the specific embodiments disclosed in the specification and the claims, but should be construed to include all security systems that operate under the claims to provide a method for security or authentication. Accordingly, the invention is not limited by the disclosure, but instead the scope of the invention is to be determined entirely by the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

We claim:

1. A computer-readable medium storing instructions for computer-implementable method for providing document security, comprising:
receiving an electronic document;
creating a document profile based on the electronic document;
creating a signer profile representing at least one aspect of a person to sign the electronic document;
generating a watermark based on the created document profile and the created signer profile; and
providing a modified document having the generated watermark secured to the electronic document.

2. The computer-readable medium of claim 1, further comprising:
printing the modified document, and wherein providing the modified document includes overlaying the generated watermark onto the electronic document.

3. The computer-readable medium of claim 1 wherein creating the signer profile includes receiving at least one response to a query posed to the signer, wherein the response forms a portion of a bit array, and wherein the bit array forms at least a portion of the watermark.

4. The computer-readable medium of claim 1 wherein the watermark includes a two-dimensional bar code image.
